(19) United States
(12) Patent Application Publication
(10) Pub. No.: US 2021/0241705 A1
(43) Pub. Date: Aug. 5, 2021

(54) MONITOR WITH VIRTUAL DISPLAYS

(71) Applicant: Hewlett-Packard Development Company, L.P., Spring, TX (US)

(72) Inventors: John W. Frederick, Spring, TX (US); David Michael Nypaver, Spring, TX (US); Wen Shin Chen, Taipei City (TW)

(73) Assignee: Hewlett-Packard Development Company, L.P., Spring, TX (US)

(21) Appl. No.: 17/048,686

(22) PCT Filed: Sep. 25, 2018
(86) PCT No.: PCT/US2018/052582

§ 371 Date: Oct. 19, 2020

(51) Int. Cl. G09G 3/34; G06F 3/14; G06F 3/147

(52) U.S. Cl. CPC G09G 3/3426; G06F 3/1454; G06F 3/147; G09G 2300/026; G09G 2340/0464; G09G 2370/16; G09G 2356/00; G09G 2354/00; G09G 2370/06

(57) ABSTRACT

Examples described herein relate to a monitor consistent with the disclosure. For instance, the monitor may comprise a display screen including a plurality of virtual displays and a video connector to receive a plurality of video streams, wherein each video stream of the plurality of video streams is directed to a virtual display of the plurality of virtual displays.

### BACKGROUND

Output devices such as monitors are utilized in a variety of computing devices. For example, monitors may be utilized to provide visual representations from a computing device to a user, among other possibilities.

### BRIEF DESCRIPTION OF THE DRAWINGS

FIG. 1 illustrates an example of a monitor consistent with the disclosure.

FIG. 2 illustrates an example of an apparatus suitable with a system consistent with the disclosure.

FIG. 3 illustrates an example of a system consistent with the disclosure.

FIG. 4 illustrates an example diagram of a non-transitory machine readable medium suitable with a system consistent with the disclosure.

FIG. 5 illustrates an example of a system including a monitor consistent with the disclosure.

### DETAILED DESCRIPTION

Monitors may include a display screen to display a visual image from a computing device. The monitor may include a video connector to connect to the computing device. The computing device may send a video stream to the monitor through a video cable connected to the video connector. As used herein, computing device refers to a device including a processor, memory, and input/output interfaces for wired and/or wireless communication.

Some monitors may not allow a display screen to include a plurality of virtual displays. In addition, some monitors may not receive a plurality of video streams from a computing device and may not direct the plurality of video streams to different virtual displays of the plurality of virtual displays on the display screen of the monitor. That is, some monitors may not cause the computing device to register the virtual displays of the monitor as separate and distinct monitors and/or display screens connected to the computing device. A monitor in accordance with the present disclosure can include a monitor with virtual displays such that the monitor includes a display screen including a plurality of virtual displays and a plurality of video streams directed to the plurality of virtual displays. A monitor including a plurality of virtual displays may allow a user to work efficiently while decreasing the amount of desk space used by an output device.

In some examples of the present disclosure, a monitor directs a plurality of video streams from a computing device to different virtual displays on a display screen and is able to increase the number of displays a user has access while decreasing the amount of desk space the monitor uses. For instance, a computing device that sends a plurality of video streams to a plurality of virtual displays of a monitor may use one monitor to view a plurality of visual images. Further, the computing device may register each virtual display as a separate and distinct monitor and/or display screens. Accordingly, this disclosure describes systems including a monitor capable of producing a plurality of virtual displays.

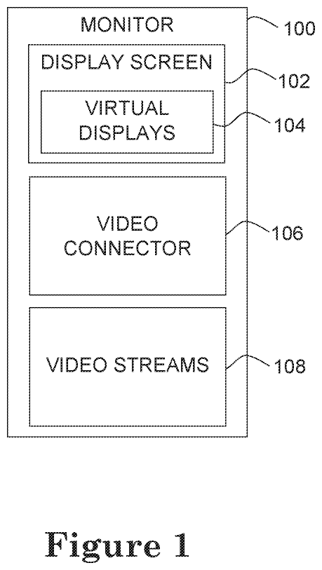

FIG. 1 illustrates an example of a monitor 100 consistent with the disclosure. The monitor 100 may be suitable with a variety of computing devices, such as laptops, desktops, tablets, etc., for example. In some examples, monitors 100 may include a display screen 102. As used herein, “display screen” refers to a surface area of a monitor which text, graphics, and/or visual images appear for viewing. The display screen 102 may display visual images from a computing device. As used herein, “visual image” refers to text, graphics, videos, and/or visual representations. In some examples, the display screen 102 may display one visual image from a computing device. In various examples, the display screen 102 may display a plurality of visual images from a computing device. As used herein, “monitor” refers to an output device which displays information from a computing device in the form of text, graphics, videos, and/or visual representations. For example, a monitor may be a television, a computer display device, or other devices that display text, graphics, videos, and/or visual representations.

In some examples, the display screen 102 may display a plurality of visual images through a plurality of virtual displays 104. For instance, the display screen 102 may include three virtual displays 104 on the one display screen 102. The virtual displays 104 may each produce a visual image that is separate and distinct from the other virtual displays 104. That is, each virtual display 104 may be used individually by a user. For example, a user may have three virtual displays 104 appearing on the display screen 102. The first virtual display may be displaying a movie, the second virtual display may be displaying a text document, and the third virtual display may be displaying a website. As used herein, “virtual display” refers to a screen formed within a display screen.

In some examples, a user may customize each virtual display of the plurality of virtual displays 104. That is, a user may customize the appearance and location of each virtual display of the plurality of virtual displays 104. For example, a user may determine the location of each virtual display on the display screen 102. As used herein, “customize” refers to the act of altering an item according to a user's specifications. In some examples, the user may determine the location on the display screen of a portion of the virtual displays 104 and use a default location for the remaining portion of virtual displays 104. For example, a user may use a default location for two virtual displays 104 of a total of three virtual displays 104 and customize the location for the remaining virtual displays 104 of the three virtual displays 104. As used herein, “default” refers to a preselected option adopted by a monitor.

In some examples, a user may individually determine the brightness, contrast, refresh rate, resolution, name, color space, etc. of each virtual display of the plurality of virtual displays 104. For example, a first virtual display of a plurality of virtual displays 104 may be brighter than a second virtual display of a plurality of virtual displays 104. The user may set different settings for each virtual display of the plurality of virtual displays 104. As used herein, “settings” refers to choices associated with the appearance and/or location of the virtual displays that may be adjusted to change the appearance and/or location of the virtual displays. In some examples, each virtual display of the plurality of virtual displays 104 may have the same settings. That is, a user may use a default setting for each virtual display. In some examples, the user may customize the settings of a portion of the virtual displays 104 and use default settings for the remaining portion of virtual displays 104. For example, a user may use a default setting for three virtual displays 104 of a total of five virtual displays 104 and use customize setting for the remaining two virtual displays 104 of the five virtual displays 104.

In some examples, a user may determine how many virtual displays appear on the display screen 102 of the monitor 100. That is, a user may add or subtract virtual displays 104 from the display screen 102 to customize the amount of virtual displays 104 on the display screen 102. The monitor 100 is able to produce a plurality of virtual displays 104 without an operating system of a computing device and/or a program of the computing device. However, the operating system of the computing device may recognize each virtual display of the plurality of virtual displays 104 as a distinct and/or separate display of a monitor 100 and/or display screen 102. That is, the operating system of the computing device may register each virtual display as a monitor 100 and/or display screen 102 having all the characteristics of a monitor 100 (e.g., controller, etc.). In some examples, the amount of virtual displays 104 a display screen is able to produce is equal to the number of visual images a computing device is able to produce. For example, if the graphic processing unit of the computing device is able to produce three visual images, then the display screen 102 may produce three virtual displays 104. However, a user may decide to display two virtual displays 104 of the three possible virtual displays 104.

In some examples, the computing device may connect to the monitor 100 via a wireless connection. For example, the computing device may connect to the monitor 100 via a Bluetooth connection. However, this disclosure is not so limited. In some examples, a computing device may connect to a monitor 100 via a video connector 106. The monitor 100 may include a plurality of video connectors 106. In some examples, the computing device may connect to the video connectors 106 with a display cable to produce video streams 108.

For example, the computing device may be connected to the monitor 100 through a DisplayPort cable, a video graphics array (VGA) cable, a universal serial bus (USB) cable, High-Definition Multimedia Interface (HDMI) etc. In some examples, the computing device may be connected to the monitor 100 through a Multi-Stream Transport (MST) cable. That is, the computing device may use a DisplayPort cable to connect to a video connector 106 of the monitor 100 to produce a plurality of video streams 106. In some examples, the display cable may produce a plurality of video streams 108 to create a plurality of virtual displays 104 on the display screen 102. Using a MST cable to produce a plurality of video streams 108 may reduce the amount of video cables used to produce a plurality of visual images. It should be understood that when an element is referred to as being “on” or “connected to” another element, it may be directly on or connected with the other element or intervening elements may be present.

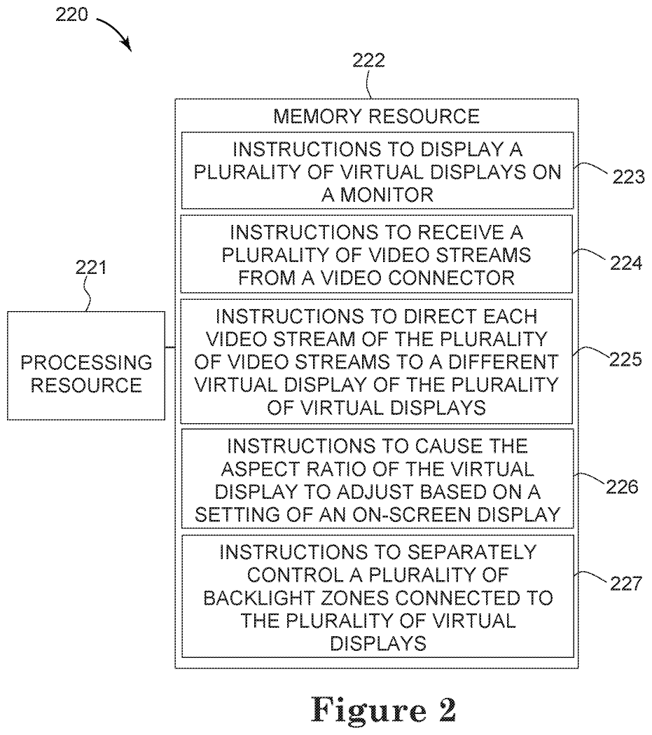

FIG. 2 illustrates an example of an apparatus 220 suitable with a system consistent with the disclosure. As illustrated in FIG. 2, the apparatus 220 includes a processing resource 221 and a memory resource 222. The processing resource 221 may be a hardware processing unit such as a microprocessor, application specific instruction set processor, coprocessor, network processor, or similar hardware circuitry that may cause machine-readable instructions to be executed. In some examples, the processing resource 221 may be a plurality of hardware processing units that may cause machine-readable instructions to be executed. The processing resource 221 may include central processing units (CPUs) among other types of processing units. The processing resource 221 may also include dedicated circuits and/or state machines, such as in an Application Specific Integrated Circuit (ASIC), Field Programmable Gate Array (FPGA) or similar design-specific hardware. The memory resource 222 may be any type of volatile or non-volatile memory or storage, such as random-access memory (RAM), flash memory, read-only memory (ROM), storage volumes, a hard disk, or a combination thereof.

The memory resource 222 may store instructions thereon, such as instructions 223, 224, 225, 226, and 227. When executed by the processing resource 221, the instructions may cause the apparatus 220 to perform specific tasks and/or functions. For example, the memory resource 222 may store instructions 223 which may be executed by the processing resource 221 to cause the apparatus 220 to display a plurality of virtual displays on a monitor. In some examples, a display screen of a monitor may display a plurality of virtual displays. The plurality of virtual displays may allow a user to view separate visual images on an individual monitor. That is, having a plurality of virtual displays on an individual monitor may allow a user to work efficiently by allowing them to view multiple visual images on one monitor. In some examples, using one monitor, as compared to two or more monitors, may conserve and/or save energy when using a computing device. In addition, using an individual monitor to produce a plurality of virtual displays may consolidate desk space and/or create more desk space for a user.

The memory resource 222 may store instructions 224 which may be executed by the processing resource 221 to cause the apparatus 220 to receive a plurality of video streams from a video connector. In some examples, the video connector of a monitor may receive a plurality of video streams from a computing device. The plurality of video streams may be sent from an individual display cable. For example, the monitor may receive a plurality of video streams from a MST cable, such as a DisplayPort cable, to allow each virtual display of the plurality of virtual displays to receive a separate visual image. The MST cable may connect to the monitor through a video connector.

The memory resource 222 may store instructions 225 which may be executed by the processing resource 221 to cause the apparatus 220 to direct each video stream of the plurality of video streams to a different virtual display of the plurality of virtual displays. In some examples, a monitor may receive a plurality of video streams and direct each video stream of the plurality of video streams to a different virtual display on the display screen of the monitor. For instance, a computing device may send a plurality of video streams to a monitor through a video connector and each video stream may be directed to a virtual display. Directing video streams to different virtual displays may allow a user to use one monitor to view a plurality of visual images.

The memory resource 222 may store instructions 226 which may be executed by the processing resource 221 to cause the apparatus 220 to cause an aspect ratio of the virtual display to adjust based on a setting of an on-screen display (OSD). In some examples, the OSD may allow a user to change the appearance of each virtual display of the plurality of virtual displays. For instance, a user may be able to change the settings of the virtual displays using the OSD. For example, the user may be able to make a virtual display of the plurality of virtual displays smaller or larger, as compared to the previous state of the virtual display, change the brightness, contrast, etc. of a virtual display.

The memory resource 222 may store instructions 227 which may be executed by the processing resource 221 to cause the apparatus 220 to separately control a plurality of backlight zones connected to the plurality of virtual displays. In some examples, the display screen of the monitor may use backlights to display a visual image on the plurality of virtual displays. The backlights may be grouped into zones to produce a plurality of backlight zones associated with the plurality of virtual displays. In some examples, the backlight zones may be selectively turned off or on. That is, the monitor may turn off a backlight zone when a virtual display is not in use. Similarly, the monitor may turn on a backlight zone when a virtual display is in use. In some examples, a user may cause a backlight zone to turn off when a virtual display is not in use by adjusting the settings on the OSD. Likewise, a user may cause a backlight zone to turn on when a virtual display is in use. For examples, if a user is not using a virtual display the user may go to the OSD to turn off the backlight zone for the virtual display not in use. In addition, if the backlight zone for a virtual display is off and a user wants to use the virtual display the user may go to the OSD to turn on the backlight zone for the virtual display.

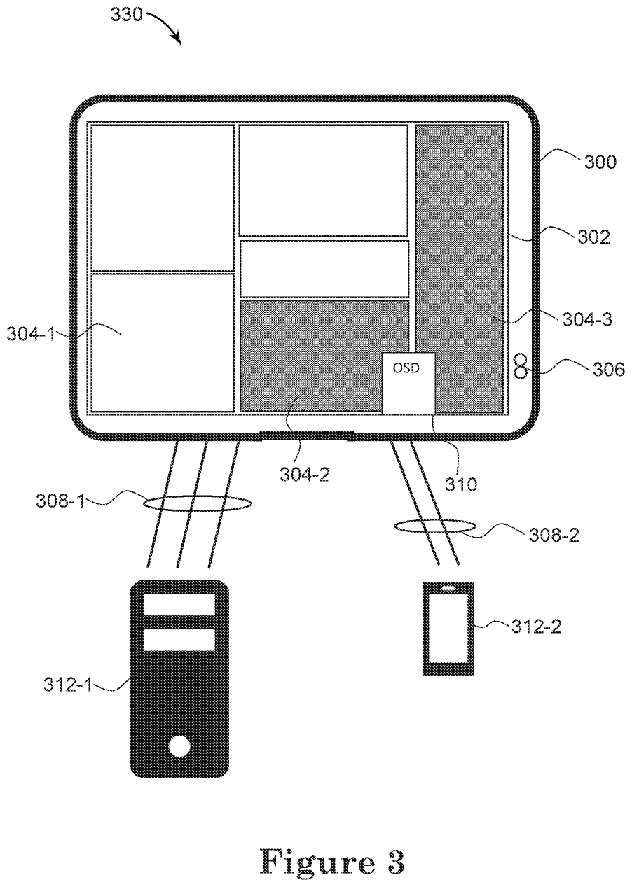

FIG. 3 illustrates an example of a system 330 consistent with the disclosure. In some examples, the system 330 may include a monitor 300, a display screen 302 and video connectors 306. Monitor 300 is analogous or similar to monitor 100 of FIG. 1. Video connectors 306 are analogous or similar to video connectors 106 of FIG. 1. Display screen 302 is analogous or similar to display screen 102 of FIG. 1. Virtual displays 304 are analogous or similar to virtual displays 104 of FIG. 1. Video streams 308 are analogous or similar to video streams 108 of FIG. 1.

In some examples, the computing device 312-1 or the computing device 312-2 (collectively referred to herein as computing devices 312) may connect to a video connector to send video streams 308-1 or 308-2 to the monitor 300. However, this disclosure is not so limited. In some examples, computing devices 312 may connect to video connectors 306 to send video streams 308 to the monitor 300. Video streams 308-1 and 308-2 may be collectively referred to as video streams 308.

In some examples, the computing devices 312 may send an individual video stream to the monitor 300. In various examples, the computing devices 312 may send a plurality of video streams 308 to the monitor 300 through a MST cable. In some examples, the operating systems of the computing devices 312 may register the virtual displays 304 as separate monitors. That is, the monitor 300 may cause the computing device to recognize the virtual displays 304 as a physical display. In some examples, the monitor 300 may receive a plurality of video streams 308 through a MST cable to connect each virtual display of the plurality of virtual displays 304 in a daisy chain. Virtual displays 304-1, 304-2, and 304-3 may be collectively referred to as virtual displays 304. As used herein, “daisy chain” refers to the ability to connect virtual displays together using a MST cable. That is, the monitor 300 may direct the plurality of video streams 308, from an individual cable, to different virtual displays 304-1, 304-2, and/or 304-3 of the plurality of virtual displays 304. In some examples, the monitor 300 may not use a graphics processing unit to produce the plurality of virtual displays 304.

In some examples, a user may use an OSD 310 to adjust the settings of each virtual display 304-1, 304-2, and/or 304-3. For example, a user may adjust the aspect ratio of each virtual display 304-1, 304-2, and/or 304-3. That is, the aspect ratio of virtual displays 304-1, 304-2, and 304-3 may each be different from one another. In some examples, adjusting the aspect ratio may allow a user to customize a virtual display to fit a particular visual image. In addition, the brightness, contrast, and color space for each virtual display may be adjusted by the user with the OSD 310. In some examples, the space between each virtual display (e.g., whitepoint) may be customized by the user. For example, the whitepoint between virtual display 304-1 and 304-2 may be larger than the whitepoint between virtual display 304-2 and 304-3.

In some examples, a user may use an OSD to turn off a virtual display 304-2 or 304-3. In various examples, the monitor may turn off a virtual display 304-2 or 304-3 that is not being used by the user.

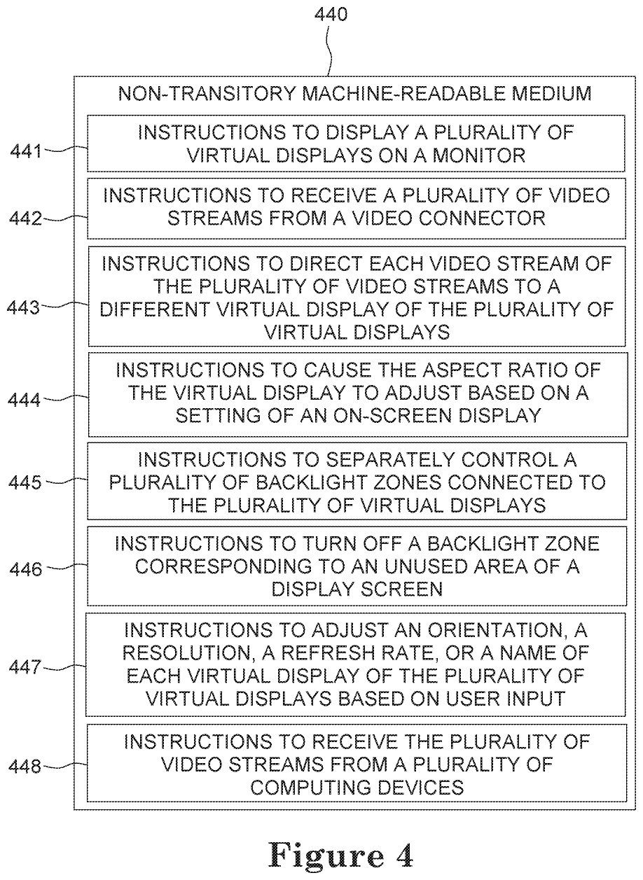

FIG. 4 illustrates an example diagram of a non-transitory machine readable medium 440 suitable with a system consistent with the disclosure. The non-transitory machine-readable medium 440 may be any type of volatile or non-volatile memory or storage, such as random-access memory (RAM), flash memory, read-only memory (ROM), storage volumes, a hard disk, or a combination thereof.

The medium 440 stores instructions 441 executable by a processing resource to display a plurality of virtual displays on a monitor. In some examples, a display screen of a monitor may display a plurality of virtual displays from a plurality of computing devices. For example, a desktop computer and a tablet may send video streams to a plurality of virtual displays on a monitor.

The medium 440 stores instructions 442 executable by a processing resource to receive a plurality of video streams from a video connector. In some examples, the monitor may include a plurality of video connectors. The plurality of video connectors may connect to a plurality of computing devices. That is, each computing device may be connected to a video connector. In addition, each computing device may send a plurality of streams to the monitor through the video connector. In some examples, a computing device may send an individual stream to the monitor through a video connector.

The medium 440 stores instructions 443 executable by a processing resource to direct each video stream of the plurality of video streams to a different virtual display of the plurality of virtual displays. In some examples each video stream may go to an individual virtual display. For example, if two computing devices send three video streams to a monitor, then the monitor may display three virtual displays to display the visual images of the three video streams. Using a plurality of virtual displays of a monitor to view a plurality of video streams may allow a user to reduce the amount of space used on a desk to hold output devices.

The medium 440 stores instructions 444 executable by a processing resource to cause the aspect ratio of the virtual display to adjust based on a setting of an OSD. In some examples, the OSD may allow a user to change the orientation, resolution, refresh rate, name, brightness, contrast, color space, etc. of each virtual display of the plurality of virtual displays. That is, a user may customize each virtual display of the plurality of virtual displays. However, this disclosure is not so limited. In some examples, the user may use a default setting for the orientation, resolution, refresh rate, name, brightness, contrast, color space, etc.

The medium 440 stores instructions 445 executable by a processing resource to separately control a plurality of backlight zones connected to the plurality of virtual displays. In some examples, the monitor may include a plurality of backlights to display visual images on the plurality of virtual displays. That is, the monitor may include a plurality of light emitting diode (LED) backlight zones included on a back panel of the monitor to provide light to a display screen of the monitor and produce a visual image on a plurality of virtual displays. In some examples, the plurality of backlight zones may be separately turned on and off to separately control a backlight zones connected to the plurality of virtual displays. In some examples, the backlight zone may be comprised of direct backlights. For instance, the LED backlights in the backlight zones may spread across the back panel of the monitor.

The medium 440 stores instructions 446 executable by a processing resource to turn off a backlight zone of the plurality of backlight zones corresponding to an unused area of a display screen. In some examples, the backlights zones may turn on and off independently of each other. For example, if a user is not using a virtual display the backlight zone associated with the unused virtual display may turn off to save energy while other backlight zones associated with used virtual displays remain on. In some examples, a user may manually cause a backlight zone to turn off and/or on. For instance, if a user is not using a virtual display the user may use an OSD to turn off the backlight zone for the virtual display.

The medium 440 stores instructions 447 executable by a processing resource to adjust an orientation, a resolution, a refresh rate, a name, or a combination thereof of each virtual display of the plurality of virtual displays based on user input. A user may set different settings for each virtual display of the plurality of virtual displays. The user may use the OSD to individually customize the virtual displays of the monitor. In addition, a user may use the default settings for the for the virtual displays. In some examples, a user may have a combination of customized virtual displays and virtual displays that use the default settings.

The medium 440 stores instructions 448 executable by a processing resource to receive the plurality of video streams from a plurality of computing devices. In some examples, the monitor may receive video streams from a plurality of computing devices. For instance, the monitor may receive video streams from a tablet and a desktop computer at the same time and display the video streams on a plurality of virtual displays.

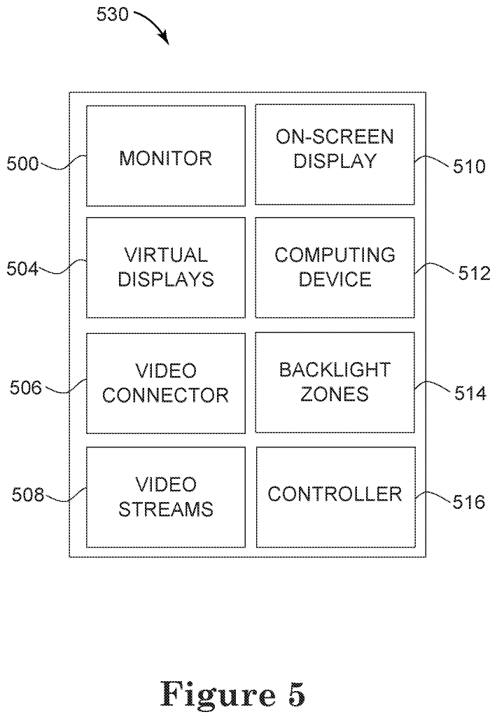

FIG. 5 illustrates an example of a system 530 including a monitor 500 consistent with the disclosure. In some examples, the system 530 may include a monitor 500, a computing device 512, a video connector 506, an OSD 510, video streams 508, and virtual displays 504. Monitor 500 is analogous or similar to monitor 100 and 300 of FIGS. 1 and 3, respectively. Video connector 506 are analogous or similar to video connectors 106 and 306 of FIGS. 1 and 3, respectively. Virtual displays 504 are analogous or similar to virtual display 104 and 304 of FIGS. 1 and 3, respectively. Video streams 508 are analogous or similar to video streams 108 and 308 of FIGS. 1 and 3, respectively. Computing device 512 is analogous or similar to computing devices 312 of FIG. 3. OSD 510 is analogous or similar to OSD 310 of FIG. 3. System 530 is analogous or similar to system 330 of FIG. 3.

In some examples, a controller 516 of the monitor 500 may direct a plurality of video streams 508 from the computing device 512 to different virtual displays 504 of the monitor 500. For instance, the controller 516 may receive a plurality of video streams 508 and direct each video stream to a different virtual display. The computing device 512 may send the plurality of video streams 508 to the monitor 500 through a MST cable allowing the controller 516 to direct each video stream of the plurality of video streams 508 to a different virtual display of the plurality of virtual displays 504.

In some examples, the monitor 500 may include a plurality of backlight zones 514 on the back panel of the monitor 500. In some examples, the backlight zones 514 may be direct LED backlights. In some examples, a user may utilize the OSD to turn on and off the backlight zone associated with a virtual display. In some examples, the controller 516 may cause the backlight zone associated with a virtual display to turn off or on. For example, the backlight zone on the back panel behind to a virtual display may turn off while, a different backlight zone associated with a different virtual display may remain on. That is, the backlight zones 514 of the monitor may selectively turn on and off. While some elements are designated as a “front” or “behind,” it should be understood that such elements may correspond to other relative terms or possible orientations in some applications in order to practice the examples of this disclosure.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

It should be understood that the descriptions of various examples may not be drawn to scale and thus, the descriptions may have a different size and/or configuration other than as shown therein.

What is claimed:

1. A monitor comprising:
a display screen including a plurality of virtual displays; and
a video connector to receive a plurality of video streams, wherein each video stream of the plurality of video streams is directed to a virtual display of the plurality of virtual displays.

2. The monitor of claim 1, further including an on-screen display (OSD) to adjust the aspect ratio of each virtual display of the plurality of virtual displays.

3. The monitor of claim 1, wherein the monitor comprises a direct backlight zone.

4. The monitor of claim 1, further including a controller to receive the plurality of video streams and direct each video stream of the plurality of video streams to a different virtual display of the plurality of virtual displays.

5. The monitor of claim 1, wherein the location of each virtual display on the display screen is determined by the user.

6. The monitor of claim 5, wherein each virtual display has a different brightness and color space.

7. A non-transitory machine-readable medium storing instructions executable by a processing resource to:
display a plurality of virtual displays on a monitor;
receive a plurality of video streams from a video connector;
direct each video stream of the plurality of video streams to a different virtual display of the plurality of virtual displays;
cause the aspect ratio of the virtual display to adjust based on a setting of an on-screen display (OSD); and
separately control a plurality of backlight zones connected to the plurality of virtual displays.

8. The non-transitory machine-readable medium of claim 7, further including instructions executable by the processing resource to turn off a backlight zone of the plurality of backlight zones corresponding to an unused area of a display screen.

9. The non-transitory machine-readable medium of claim 7, further including instructions executable by the processing resource to adjust an orientation, a resolution, a refresh rate, a name, or a combination thereof of each virtual display of the plurality of virtual displays based on user input.

10. The non-transitory machine-readable medium of claim 7, further comprising instructions executable by the processing resource to receive the plurality of video streams from a plurality of computing devices.

11. A system comprising:
a monitor including a plurality of virtual displays;
a first computing device to send a first plurality of video streams;
a first video connector to receive the first plurality of video streams from the first computing device, wherein each video stream of the first plurality of video streams is directed to a different virtual display of the plurality of virtual displays; and
an on-screen display (OSD) to adjust an aspect ratio of each virtual display of the plurality of virtual displays.

12. The system of claim 11, further comprising a second video connector to receive a second plurality of video streams from a second computing device.

13. The system of claim 11, wherein each virtual display of the plurality of virtual displays has a separate refresh rate.

14. The system of claim 13, wherein each virtual display of the plurality of virtual displays has a separate contrast.

15. The system of claim 11, further comprising a plurality of light-emitting diode (LED) backlights included on a back panel of the monitor to provide light to a display screen of the monitor and produce a visual image on the display screen.
